(19) United States
(12) Patent Application Publication
(10) Pub. No.: US 2009/0307172 A1
(43) Pub. Date: Dec. 10, 2009

(54) RETROACTIVE POLICY ENFORCEMENT

(75) Inventors: Craig V. McMurtry, Sammamish, WA (US); Jack Kabat, Sammamish, WA (US); Nima Ganjeh, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/239,439

(22) Filed: Sep. 26, 2008

Related U.S. Application Data
(60) Provisional application No. 61/059,572, filed on Jun. 6, 2008.

(51) Int. Cl. G06N 5/02

(52) U.S. Cl. 706/47

(57) ABSTRACT

Disclosed herein is a system and method for enforcement of management policies by automatically trigging action-based processes that are mapped to the management policies. This may occur when: a new management policy is created; a final set of a management policy is modified; a new workflow is added to the management policy; and the membership filter or explicit membership of a set referenced by the management policy's final set is modified.

### CROSS-REFERENCE TO RELATED APPLICATIONS

This application claims the benefit of U.S. Provisional Application No. 61/059,572 filed Jun. 6, 2008 which is hereby incorporated by reference in its entirety.

### BACKGROUND

Management policy rules, or management policies, define actions that are performed as a result of a request occurring in a system. A workflow may apply a policy to one or more objects in a set as a result of a CRUD (Create/Read/Update/Delete) activity. However, no method currently exists for retroactively enforcing a workflow of a management policy rule to objects of a particular set or sets.

### SUMMARY

Embodiments described herein disclose a system and method to retroactively enforce management policy rule(s) (“MPR(s)”) on objects or resources that are in an “out of policy” state. Also described herein is a system and method that enforce MPRs on resources or objects that are newly included in a set as a result of the definition of the set being modified (i.e., a change in the set's membership filter).

In an embodiment, a workflow of a management policy rule may be retroactively enforced to one or more objects of a target set by identifying the target set, identifying the one or more objects of the target set, determining whether the one or more objects of the target set is in an out of policy state, and automatically enforcing the workflow of the management policy rule to the one or more objects that are in the out of policy state. According to an embodiment, a user or administrator of the system may selectively choose whether to retroactively enforce the new workflow to the objects in the target set or whether to enforce the existing workflow to objects that have been added to a set based on a change to the set's membership filter.

Retroactive enforcement of management policies is accomplished by automatically triggering workflows that are mapped to management policies when: a management policy is created; a final set of a management policy is modified; a new workflow is added to the management policy; and the membership filter or explicit membership of a set referenced by a management policy's final set is modified.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Embodiments of the present disclosure may be more readily described by reference to the accompanying drawings in which like numbers refer to like items and in which:

FIG. 1 illustrates a method for retroactively enforcing a workflow of a newly created MPR to objects of a target set according to an embodiment.

FIG. 2 illustrates a method for retroactively enforcing a workflow of an updated MPR to objects of a target set according to an embodiment.

FIG. 3A illustrates a method for retroactively enforcing a workflow to objects of a target set when the target set's membership filter is modified according to an embodiment.

FIG. 3B illustrates a method for retroactively enforcing a workflow to objects of a new target set when a management policy rule has been updated according to an embodiment.

FIG. 4 is a functional diagram illustrating a computer environment and computer system according to an embodiment.

### DETAILED DESCRIPTION

This disclosure will now more fully describe exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

In an embodiment, a workflow of a management policy rule may be retroactively enforced to one or more objects of a target set. The objects in the target set include objects that currently meet, or at one time did meet, certain criteria. Membership conditions or properties of an object determine, in part, whether the object is part of a given set. The set the object belongs to determines the policies that are enforced on the object and whether the object is in an out of policy state. In an embodiment, an object can be part of more two or more different sets. Thus, when determining what objects and/or sets will be updated based on a changed management policy rule, the system may be configured to only look at sets with objects that will be affected by the update. Alternatively, the system may identify sets having a particular definition (e.g., office location, employee name, employee type etc.).

In another embodiment, a set may define a group. A group may be divided into two categories, a distribution group or a security group. When a group is created, for example a security group, the security group may have an expiry date. In an embodiment, the expiry date cannot be longer than a set period of time (e.g., one year). When the group is created, it may be monitored by a system. The system may monitor the group to determine whether the group has reached the expiry date or whether the expiry date is upcoming (e.g., within the next two weeks). Once the date has been reached, the system expires the group and all policies governing the group are no longer valid. The system may provide to an administrator options to extend the expiry date of various groups.

According to yet another embodiment, retroactively enforcing a workflow of a management policy rule includes identifying the target set, identifying the one or more objects of the target set, determining whether the one or more objects of the target set is in an out of policy state, and automatically enforcing the workflow of the management policy rule to the one or more objects that are in the out of policy state. According to an embodiment the target set or final set specifies the set that the resource must belong to after a request in order for the management policy rule to be enforced. Workflows mapped to a management policy rule are only applied to objects that exist in the management policy rule's final set.

In an embodiment, a user of the system may selectively choose whether to retroactively enforce the new workflow to the objects in the target set or whether to enforce the existing workflow to objects that have been added to a set based on a change to the set's membership filter. In yet another embodiment, and as discussed above, a workflow may be enforced to a set based on temporal restraints (i.e., a predetermined number of days have passed since objects of a set have been given certain privileges associated with the policy rules). In still yet another embodiment, a MPR may have more than one workflow associated with it, with each workflow having zero or more policies. In such an embodiment some of workflows may be retroactively enforced while others may not be retroactively enforced. In still yet another embodiment, when an object has changed or been updated all workflows with their corresponding policies may be identified and run in parallel on the identified object or objects.

The disclosed enforcement of management policies is accomplished by automatically trigging action-based processes that are mapped to the management policies. This may occur when: a new management policy is created; a final set of a management policy is modified; a new workflow is added to the management policy; and the membership filter or explicit membership of a set referenced by the management policy's final set is modified.

An example of requests that trigger action-based processes, and the resulting action, is shown in the following table and will be described in more detail below.

TABLE 1

| Request | Resulting Action |
|---|---|
| Create new MPR | Enforce each workflow referenced by the new MPR's |
| | action workflow definition to each member of the set |
| | referenced by final set of the resource. |
| Modify the final set of | Enforce each workflow referenced by the target MPR's |
| MPR | action workflow definition to each member of the set |
| | referenced by the final set. |
| Add reference to new | Enforce the newly added workflow to each member of the |
| workflow to MPR's action | set referenced by the target MPR's final set |
| workflow definition | |
| Update filter of a set | Enforce each workflow mapped to the MPR (whose final |
| | set references the target set being updated) to each object |
| | that transitioned into the set because of the filter update |
| Update explicit | Enforce each state-based workflow referenced by action |
| membership of a set | workflow definition to each object that transitioned into |
| | the set because of the membership update |

When a request, as indicated in Table 1, is made on a target set or on a management policy rule which warrants a retroactive workflow, only workflows that are associated with the management policy rules that meet certain criteria are triggered. One such example is when the management policy rule's final set does not reference the same set as its current set. In such a case, the management policy is mapping a workflow to a state transition (i.e., enforcing a workflow to an object that is “out of policy”).

Another example of when a request on a set or MPR warrants the triggering of retroactive workflows is when the principal making the request on the set or MPR is a member of the principal set of the MPR that has been triggered. In either case, only state-based workflows that are mapped to the MPR will be run.

### Creation of New Management Policy Rule

When a management policy that maps workflows to a set transition is created, all retroactive workflows that mapped must be applied to each member of the management policy's final set. Thus, the new management policy is enforced on objects that are already in an out of compliance state when the new management policy is created.

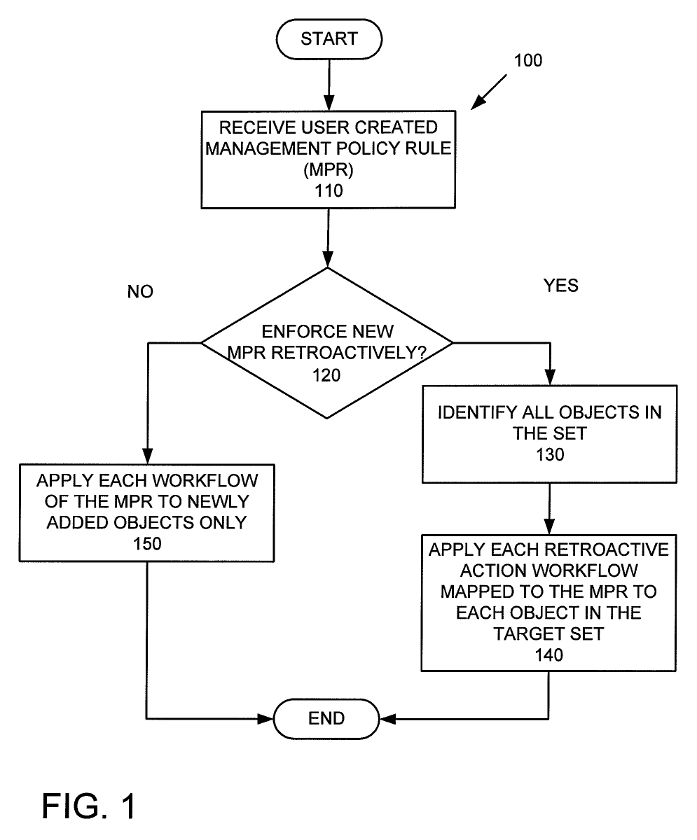

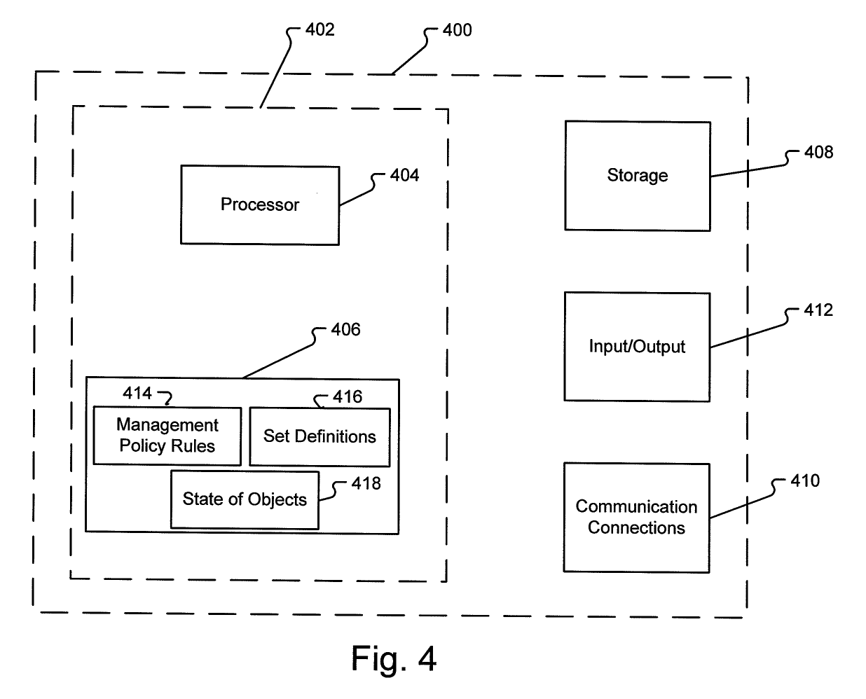

FIG. 1 illustrates a method 100 for retroactively enforcing a workflow of a newly created management policy rule (MPR) to objects of a target set. In step 110, a system (e.g., system 400 described with respect to FIG. 4) receives a newly created management policy rule. The newly created MPR may include zero or more references to desired processes, or workflows, that are to be run on objects of a target set. For example, an administrator may wish to grant all full time employees of Company A remote access service (RAS) access. To accomplish this, the administrator may create a management policy rule “Grant FTE entitlements” which specifies that when a person (i.e., object associated with the person) enters the “Full Time Employees” set, a process is launched which will grant the person RAS access. As part of the creation process, an administrator may select the target set to which the newly created policy is to be enforced against.

In step 120, a determination is made as to whether any workflows in the new MPR are to be retroactively enforced to objects of the target set. In embodiments, in order to identify workflows that can be triggered based on the set an object is in, a specific property, for example, a run on policy update property, may be added to a workflow definition object. In this embodiment, the attribute indicates whether the workflow can be applied retroactively to objects based on set membership (i.e., an object in an “out of policy” state), or if the workflow must be applied to objects as a result of a request.

According to an embodiment, when a workflow is created, the administrator may manually select (through the use of a radio button, check box etc. on a user-interface), whether the new workflow should be retroactively applied. If the new MPR contains any such retroactive workflows, they will be retroactively applied to each object already associated with the target set prior to the creation of the MPR.

If the administrator desires that workflows in the new MPR will be applied retroactively, flow passes to step 130 where all objects in the target set are identified. According to an embodiment, a state of each object is checked to determine whether the object has certain criteria associated with the target set. Continuing with the example from above, step 130 provides that each object associated with the “Full Time Employee” set is identified.

In step 140, a process is launched which enforces each retroactive action workflow mapped to the MPR to each object in the target set. For example, each object associated with the Full Time Employee target set will be given RAS access. Thus, each person or object previously identified as a full time employee prior to the newly created MPR workflow should be given RAS access. In addition, people or objects identified as full time employees and added to the target set after the new MPR workflow was created will also be given RAS access.

According to an embodiment, workflows may be retroactively enforced in a set referenced by an MPR when the MPR's final set does not reference the same set as its current set. Additionally, each MPR may have zero or more workflows associated it with it. Therefore, more than one action workflow may be enforced in step 140.

However, if it is determined in step 120 that the new MPR is not to be enforced retroactively, the method proceeds to step 150. Step 150 provides that the workflows of the MPR will only be enforced against newly created objects added to the target set after creation of the new MPR. Thus, in the example above, only people or objects created and associated with the Full Time Employee set after the creation of the new MPR will be granted RAS access.

### Management Policy Rule Update

When a management policy that maps workflows to a set transition is updated, all of the retroactive workflows that are mapped to the management policy must be applied to each member of the management policy's final set.

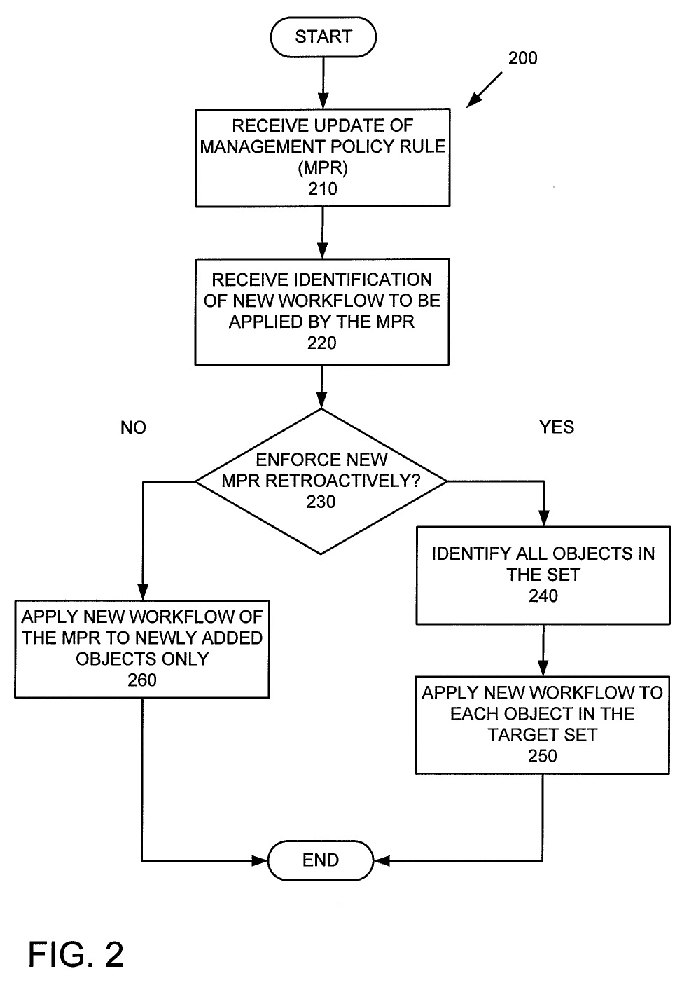

FIG. 2 illustrates a method 200 for retroactively enforcing a workflow of an updated MPR to objects of a target set. In step 210, a system receives an update of an existing management policy rule. For example, Company A may wish to extend its policy to grant full time employees Active Directory (“AD”) user accounts in addition to giving them RAS access. To accomplish this task, the administrator modifies the “Grant FTE entitlements” MPR by adding a new workflow, i.e., granting AD user accounts.

In addition to updating the MPR, an administrator may also identify the target set to which the updated MPR is to be enforced against (i.e., Full Time Employee set). The target set identified may be the set to which the MPR previously applied, or alternatively, the set may be an entirely new set.

In step 220, identification of a new workflow to be applied by the MPR is received. This identification may be made by an administrator when the MPR is updated. Alternatively, a system may identify the new workflow to be enforced.

In step 230 a determination is made as to whether any workflows in the updated MPR are to be retroactively enforced against the target set. According to an embodiment, when the workflow is created, the administrator may manually select (through the use of a radio button, check box etc. on a user-interface), whether the workflow will be retroactively applied when it is mapped to the MPR. As stated, there may be zero or more workflows that may be retroactively enforced.

If it is determined that the updated MPR should be retroactively enforced, step 240 provides that all objects in the target set are identified. In step 250 each new retroactive workflow is enforced against each object in the target set.

Continuing the example from above, each object associated with the “Full Time Employee” set will be identified and each object currently in the set will be given an AD user account in addition to having RAS access.

If however, a determination is made at step 230 that the updated MPR is not to be retroactively enforced, the method 200 continues to step 260 which provides that the updated policy will only be enforced against newly created objects added to the target set after the policy has been updated. Thus, objects that currently exist in the target set will not be given an AD account and will only have RAS Access.

### Modification of a Target Set's Filter

In contrast to when a management policy rule is updated and the updated policy is enforced to all objects of the current set, when the explicit membership or membership filter of a set referenced by the final set of a management policy is updated, all of the retroactive workflows mapped to the management policy must be enforced against each of the new members of the set.

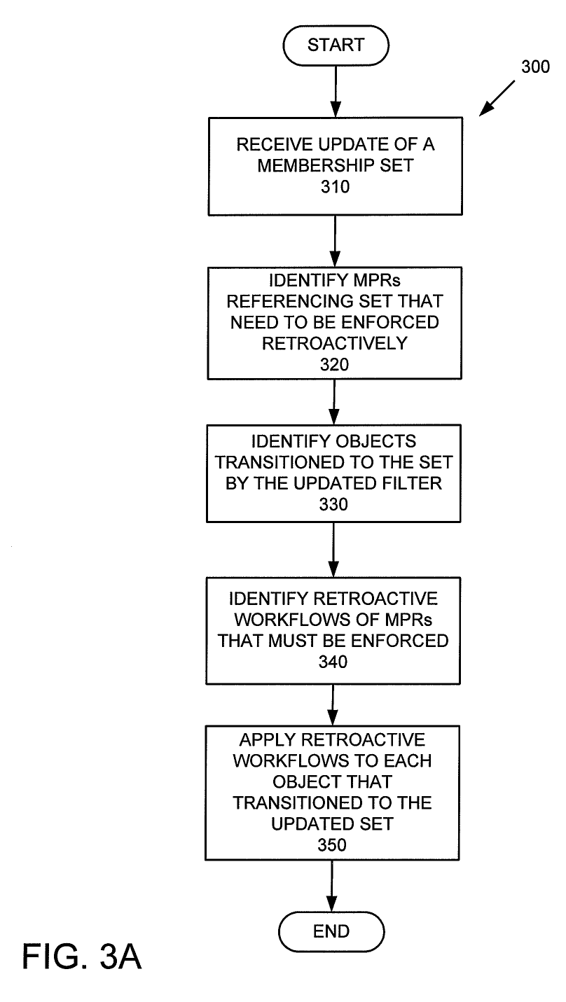

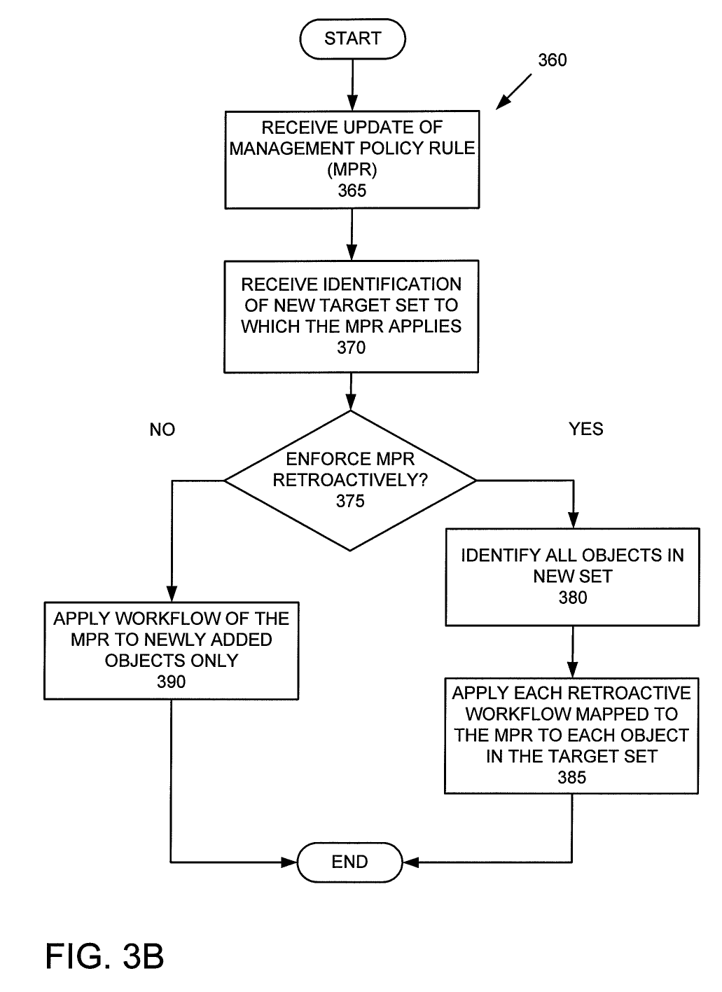

FIG. 3A illustrates a method 300 for retroactively enforcing a workflow to objects of a target set when the target set's membership filter is modified. In step 310 an update of a membership set is received. According to an embodiment, an administrator of the system may manually update the membership set or filter of the membership set. For example, Company A may have previously considered only permanent employees as full time employees but now wishes to consider interns as full time employees. The administrator extends the Full Time Employee set's membership filter to include interns. As a result, the “Grant FTE entitlements” MPR that references the Full Time Employee set grants RAS access and AD user accounts to all interns that transitioned to the set as a result of the change.

In step 320, MPRs are identified which reference the set that need to be retroactively enforced. Once identified, step 330 provides that objects that transitioned to the set (e.g. interns) by the updated filter are to be identified.

Once the objects are identified, the method flows to step 340 workflows of the MPRs that need to be retroactively enforced are identified.

Step 350 provides that the retroactive workflows of the management policy rules are applied to each object that transitioned into the set. As explained, each intern object that existed in the system and transitioned to the Full Time Employee set is given RAS access and an AD user account.

FIG. 3B illustrates a method 360 for retroactively enforcing a workflow against objects of a new target set when a management policy rule has been updated. In step 365 an update of an MPR is received. According to an embodiment, the update to the MPR may be changing the target set to which the MPR is currently associated with to a second, different target set. For example, Company A may wish change the “Grant FTE entitlements” MPR from being applied to the “Full Time Employees” set to being applied to a “Part Time Employees” set. In another embodiment, the update to the MPR may be a change or update in the policy associated with the MPR.

Once the MPR has been updated, flow proceeds to step 370 where identification of the new target set to which the MPR applies is received. Alternatively, in the case where the policy has been updated or changed, the target set may be the same set to which the MPR first, and still does, apply. Continuing the example and as stated above, this step provides that an identification is made that the “Grant FTE entitlements” is going to be applied to the “Part Time Employees” set instead of the “Full Time Employees” set.

In step 375, a determination is made as to whether the MPR is to be retroactively enforced against the objects in the new target set. If yes, flow proceeds to step 380 where all objects in the new set (i.e., the “Part Time Employees” set) are identified. After all objects in the set are identified, step 385 provides that each retroactive workflow that mapped to the MPR is enforced against each object in the target set. Thus, finishing the example from above, each person associated with the “Part Time Employee” set will be given RAS access.

If however the determination is made that the MPR will not be enforced retroactively in step 375, flow proceeds to step 390 and the MPR workflows will only be enforced against newly added objects.

### Exemplary System

With reference to FIG. 4, an embodiment of a computing environment for implementing the various embodiments described herein includes a computer system, such as computer system 400. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 400 comprises at least one processing unit or processor 404 and system memory 406. The most basic configuration of the computer system 400 is illustrated in FIG. 4 by dashed line 402. In some embodiments, one or more components of the described system are loaded into system memory 406 and executed by the processing unit 404 from system memory 406. Depending on the exact configuration and type of computer system 400, system memory 406 may be volatile (such as RAM), non-volatile (such as ROM, flash memory, etc.), or some combination of the two.

Additionally, computer system 400 may also have additional features/functionality. For example, computer system 400 includes additional storage media 408, such as removable and/or non-removable storage, including, but not limited to, magnetic or optical disks or tape. In some embodiments, software or executable code and any data used for the described system is permanently stored in storage media 408. Storage media 408 includes volatile and non-volatile, removable and non-removable media implemented in any method or technology for storage of information such as computer readable instructions, data structures, program modules, or other data. In embodiments, the capability negotiation methods and wrapper inner methods are stored in storage media 408.

System memory 406 and storage media 408 are examples of computer storage media. Computer storage media includes, but is not limited to, RAM, ROM, EEPROM, flash memory or other memory technology, CD-ROM, digital versatile disks (“DVD”) or other optical storage, magnetic cassettes, magnetic tape, magnetic disk storage, other magnetic storage devices, or any other medium which is used to store the desired information and which is accessed by computer system 400 and processor 404. Any such computer storage media may be part of computer system 400. In embodiments, system memory 406 and/or storage media 408 stores data used to perform the methods or form the system(s) disclosed herein. In embodiments, system memory 406 stores information such as management policy rules 414, set definitions 416, and the state of each object of the system 418.

Computer system 400 may also contain communications connection(s) 410 that allow the device to communicate with other devices. In embodiments, communications connection(s) 410 may be used to transmit and receive messages between sender devices, intermediary devices, and recipient devices. Communication connection(s) 410 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, the methods described above may be transmitted over the communication connection(s) 410.

In some embodiments, computer system 400 also includes input and output connections 412, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 412 are used to display the information as described herein. All these devices are well known in the art and need not be discussed at length here.

In some embodiments, the component described herein comprise such modules or instructions executable by computer system 400 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 400 is part of a network that stores data in remote storage media for use by the computer system 400.

This disclosure described some embodiments of the present disclosure with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present disclosure. Therefore, the specific structure, acts, or media are disclosed only as illustrative embodiments. The disclosure is defined by the appended claims.

What is claimed is:

1. A method for retroactively enforcing a workflow of a management policy rule to one or more objects of a target set, the method comprising:
identifying the target set;
identifying the one or more objects of the target set;
determining whether the one or more objects of the target set is in an out of policy state; and
automatically applying the workflow of the management policy rule against the one or more objects that are in the out of policy state.

2. The method of claim 1, further comprising determining whether the workflow is to be applied against each of the one or more objects in the set.

3. The method of claim 1, further comprising determining whether the workflow is to be applied against new objects of the set only.

4. The method of claim 1, further comprising monitoring the target set with a business policy.

5. The method of claim 1, further comprising flagging the workflow to indicate the workflow is to be enforced retroactively.

6. The method of claim 1, wherein at least one of the one or more objects is a member of more than one set.

7. The method of claim 1, wherein the target set may be associated with a group and wherein the group may be associated with an expiry date.

8. The method of claim 7, further comprising expiring a group when a policy expiration date has been reached.

9. The method of claim 1, wherein automatically enforcing the workflow of the management policy rule against the one or more objects that are in the out of policy state comprises identifying all applicable policies and workflows and running each of the policies and the workflows in parallel.

10. The method of claim 1, wherein determining whether the one or more objects of the target set is in an out of policy state includes determining whether a new management policy has been created.

11. The method of claim 1, wherein determining whether the one or more objects of the target set is in an out of policy state includes determining whether the target set of a management policy has been modified.

12. The method of claim 1, wherein determining whether the one or more objects of the target set is in an out of policy state includes determining whether a new workflow has been added to the management policy.

13. The method of claim 1, wherein determining whether the one or more objects of the target set is in an out of policy state comprises determining whether the membership filter of a set referenced by the management policy's final set is modified.

14. The method of claim 1, wherein identifying the one or more objects of the target set includes identifying membership conditions of an object, the membership conditions specifying minimal properties the object must have to be part of a set.

15. A computer storage medium encoding computer readable instructions for executing a method to retroactively enforce a workflow of a management policy rule to one or more objects of a target set, the method comprising:
receiving an update to the management policy rule;
identifying the target set;
identifying the one or more objects of the target set;
determining whether the updated management policy rule is to be enforced retroactively;
when it is determined that the management policy rule is to be enforced retroactively:
identifying one or more objects of the target set that is in an out of policy state; and
automatically applying the workflow of the updated management policy rule against the one or more objects that are in the out of policy state; and
when it is determined that the updated management policy rule is not to be inforce retroactively, applying the workflow of the updated management policy against newly added objects only.

16. The computer storage medium of claim 15, wherein at least one of the one or more objects is a member of more than one set.

17. The computer storage medium of claim 15, wherein membership conditions define properties of an object by which the object is included as a member of the set.

18. The computer storage medium of claim 15, wherein identifying the target set comprises identifying one or more sets that have objects that are affected by the updated management policy rule.

19. A system configured to retroactively enforce a workflow of a management policy rule to one or more objects of a target set, the system comprising:
a processor; and
a memory coupled to the processor, the memory comprising computer-program instructions executable by the processor for:
identifying the target set, wherein the target set is identified based on the type of objects in the set;
identifying the state of each object in the target set;
for each object identified as being in an out of policy state, automatically applying the workflow of the management policy rule against the identified one or more objects that are in the out of policy state.

20. The system of claim 19, wherein at least one of the one or more objects are in multiple sets.
